(19) United States
(12) Patent Application Publication
(10) Pub. No.: US 2025/0144710 A1
(43) Pub. Date: May 8, 2025

(54) SYSTEMS AND METHODS FOR IN-SITU REGOLITH AND METAL FUEL REACTIONS FOR ADDITIVE MANUFACTURING

(71) Applicant: Oqab Dietrich Induction Inc., Kitchener (CA)

(72) Inventors: Haroon B. Oqab, Kitchener (CA); George B. Dietrich, Kitchener (CA); Boyu Li, Kitchener (CA); Anqi Wang, Waterloo (CA); Jean-Pierre Hickey, Kitchener (CA); John Z. Wen, Waterloo (CA); Connor J. MacRobbie, Kitchener (CA)

(21) Appl. No.: 18/936,880

(22) Filed: Nov. 4, 2024

Related U.S. Application Data
(60) Provisional application No. 63/595,721, filed on Nov. 2, 2023.

(51) Int. Cl. B22F 10/20; B22F 3/11; B33Y 10/00; B33Y 30/00

(52) U.S. Cl. CPC B22F 10/20; B22F 3/1143; B22F 2201/20; B22F 2301/052; B22F 2301/058; B33Y 10/00; B33Y 30/00

(57) ABSTRACT

Provided are system and methods for additive manufacturing, especially using regolith. A system comprises a vacuum chamber configured to contain a material, wherein the material includes a metal fuel and an oxidizer, and an ignition source configured to ignite the material to combustion. The metal fuel includes at least one of magnesium and aluminum. The oxidizer is at least one of lunar regolith, Martian regolith, or a regolith simulant. The systems and methods provide a mechanism for sustainable production of fuels from regolith materials, with limited or not resource requirements from Earth, resulting in more sustainable space exploration.

### TECHNICAL FIELD

The following relates generally to space resources processing and, more particularly, to systems and methods for in-situ regolith and metal fuel reactions for additive manufacturing and construction.

### INTRODUCTION

The continued push for space exploration by commercial and government agencies is driving the development of new space technologies. One key industry that will be critical for majority of work done in space is space-based manufacturing. Advanced lunar manufacturing methods will be required to support the planned missions to the lunar surface by supplying parts on demand. The lunar surface will also be an ideal test bed for the further development of Martian technologies.

Additive manufacturing (AM) is a suitable candidate for much of the manufacturing requirements of missions as it provides a versatile method of creating parts and structures on location from simple feed stocks. In a recent study of technological shortfalls for future exploration, science, and other mission needs published by NASA, stakeholders in the space industry identified that AM methods needs to be further developed. Current AM methods are power intensive, require unsustainable additives, are not optimized for altered gravity or vacuum conditions, and are not equipped for large scale manufacturing.

Research groups have worked towards developing methods for lunar, Martian, and space AM by altering how they operate in the various gravity environments. Magnesium and aluminum are metal fuels which can store a high amount of energy to be released upon reaction with an oxide. The energy released during the reaction between a metal fuel and oxide rich lunar regolith (and potentially other regolith) can be used for metal production, heat and power generation, propulsion, and other purposes. Beneficially, magnesium is one of the richest elements on the Moon and may be manufactured in situ, possibly without using any Earth-sourced material.

The production of materials created from regolith and magnesium or aluminum combustion has been previously evaluated in microgravity using parabolic flights. However, a strong focus has been on the combustion and thermodynamic properties of the mixture rather than the structural properties.

Earth-based ground technologies have also been created to simulate altered gravity conditions for short periods of time using drop towers. The effects of AM under these simulated lunar gravity and microgravity environments using a drop tower have been previously researched recently for the first time for the selective laser melting method. Most recently a wire deposition method was demonstrated via laser melting in space onboard the International Space Station (ISS) demonstrating the first in space AM process, creating small stainless-steel parts a few centimeters in size. The effects of the altered gravity conditions on the physical properties of the AM parts are important for optimal design and manufacturing of AM parts in space.

For sustainable habitation and activity on the Moon and Mars, in-situ materials are needed to be used for construction and manufacturing. For a long time, lunar regolith has been investigated as a potential source of raw material and energy production. The top layer of the lunar surface down to about 15 meters is composed of minerals primarily containing Oxygen (O), silicon (Si), aluminum (Al), calcium (Ca), iron (Fe), magnesium (Mg), and titanium (Ti) with particle sizes ranging from microns to larger rocks.

With its abundance of useful elements, many uses of lunar regolith have been researched, including: oxygen generation, metal extraction, radiation shielding, and raw material for construction and additive manufacturing. Martian regolith has a generally similar mineral composition to the Moon, having slightly higher iron concentration and lower aluminum and calcium concentration, and can have applications in the same areas. If regolith materials could be used as the primary feedstock for AM methods, fewer materials would need to be brought from Earth, reducing the cost, and time required to obtain a final product.

There are several different types of known AM methods that use regolith simulant as feedstock. Many of the methods are derived from Earth based metal AM processes as these are well defined and can be iterated upon rapidly. An example of a regolith-based AM method is molten regolith extrusion, which uses extremely high temperatures to melt and deposit molten regolith onto a substrate. Another method is lithography-based ceramic manufacturing, which is a vat polymerization technique that uses a binder sensitive to light exposure to bind layers of simulant together. Other techniques such as binder or ink jetting directly incorporate a self setting binder with regolith embedded within it as the main structural component. Several sintering methods have been researched to cause adjacent simulant particles to bind to one another due to melting and re-solidification including selective laser sintering, microwave sintering, and solar sintering using concentrated sunlight. Multiple reviews cover an even larger number of alternative methods for regolith-based AM demonstrating the wide range of capabilities and engineering opportunities to additively manufacture parts and build construction materials out of regolith.

One major challenge with such techniques is that they require immense amounts of power. To address the issues of high-power consumption and sustainable manufacturing, AM research has began utilizing thermite reactions to generate power in-situ for manufacturing.

As mentioned previously, lunar and Martian regolith are composed of minerals that contain large amounts of oxygen. With sufficient heat, these oxygen containing minerals may be used as an oxidizer to react with metal fuels in an exothermic thermite combustion, releasing large amounts of heat and energy. These high temperature reactions may allow metal fuel/regolith mixtures to sinter together into bricklike structures for construction and manufacturing. Magnesium and aluminum are typical metal fuels used in thermite reactions. Thermodynamic analysis has been completed to evaluate the reacting temperatures of magnesium and aluminum with lunar regolith, demonstrating high temperatures that could be used for sintering regolith together.

Experiments have previously demonstrated that magnesium fuel and ball milled lunar regolith simulant oxidizer is able to sinter together during combustion. However, such experiments have prioritized heat release for energy harvesting, and are not optimized for AM. It been found that highly porous samples with poor physical properties remain after combustion due to the evaporation of magnesium and magnesium oxide.

Accordingly, there is a need for an improved system and method for in-situ regolith reactions for lunar and Martian additive manufacturing that overcomes at least some of the disadvantages of existing systems and methods.

This background information is provided to reveal information believed by the applicant to be of possible relevance to the present disclosure. No admission is necessarily intended, nor should be construed, that any of the preceding information constitutes prior art against the present disclosure.

### SUMMARY

Provided herein is a system for additive manufacturing, the system comprising a vacuum chamber configured to contain a material, wherein the material includes a metal fuel and an oxidizer, an ignition source configured to ignite the material to combustion.

The metal fuel may include at least one of magnesium and aluminum.

The material composition may be at least one of: 20% magnesium, 10% aluminum, 70% oxidizer; 15% magnesium, 15% aluminum, 70% oxidizer; 10% magnesium, 20% aluminum, 70% oxidizer; 20% magnesium, 80% oxidizer; 30% magnesium, 90% oxidizer; and 40% magnesium, 60% oxidizer.

The oxidizer may be at least one of lunar regolith; Martian regolith; regolith simulant; materials from Earth; and space debris.

The regolith simulant may be one of: JSC-1A and Greenspar 90.

The lunar regolith may be a mare regolith.

The lunar regolith may be a highland regolith.

The pressure inside the vacuum chamber may be less than 200 Pa.

The ignition source may be a laser.

Provided herein is a method of additive manufacturing, the method comprising providing a material in a vacuum chamber, wherein the material includes a metal fuel and an oxidizer, and igniting the material to combustion.

The metal fuel may include at least one of magnesium and aluminum.

The material composition may be at least one of: 20% magnesium, 10% aluminum, 70% oxidizer; 15% magnesium, 15% aluminum, 70% oxidizer; 10% magnesium, 20% aluminum, 70% oxidizer; 20% magnesium, 80% oxidizer; 30% magnesium, 70% oxidizer; and 40% magnesium, 60% oxidizer.

The oxidizer may be at least one of lunar regolith; Martian regolith; regolith simulant; materials from Earth; and space debris.

The regolith simulant may be one of JSC-1A and Greenspar 90.

The lunar regolith may be a mare regolith.

The lunar regolith may be a highland regolith.

The pressure inside the vacuum chamber may be less than 200 Pa.

Igniting may include using a laser.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic of an example system for additive manufacturing, according to an embodiment;

FIG. 2 is a is a flowchart of an example method of additive manufacturing, according to an embodiment;

FIG. 3 is a diagram of another example system for additive manufacturing, according to an embodiment;

FIG. 4 is a collection of example images of material characterization before combustion, according to an embodiment;

FIG. 5 is a collection of graphs of properties to materials during and after combustion, according to an embodiment;

FIG. 6 is an example high-speed imaging of a Mg—Al-alloy-simulant sample, according to an embodiment;

FIG. 7 is a collection of microscopic images of post-combustion of differing pellets, according to an embodiment;

FIG. 8A is a graph for an activity test performed with thermogravimetric analysis-differential scanning calorimetry (TGA-DSC) for regolith simulants JSC-1A and Greenspar 90;

FIG. 8B is a table of theoretical and experimental energy release for FIG. 8A;

FIGS. 9A-C shows results for reactions of various percentages of Mg with JSC-1A in a TGA-DSC activity test (9A), onset temperature, peak temperature, and energy release (9B), and activation energy (9C);

FIGS. 10A and 10B are graphs of x-ray diffraction (XRD) for compounds and elements present before (10A) and after (10B) a reaction of 20%, 30%, or 40% Mg with JSC-1A;

FIG. 11 are scanning electron microscope (SEM) images of JSC-1A and Greenspar 90 before and after ball milling;

FIGS. 12A-D are SEM images of 20% Mg with JSC-1A before and after a reaction as well as the locations of various elements within the mixture in the images;

FIGS. 13A-D are SEM images of 30% Mg with JSC-1A before and after a reaction as well as the locations of various elements within the mixture in the images;

FIGS. 14A-D are SEM images of 40% Mg with JSC-1A before and after a reaction as well as the locations of various elements within the mixture in the images;

FIG. 15 is an image of a combustion test of Mg with JSC-1A.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” should be read as including variation from the nominal value, for example, a +/−10% variation from the nominal value. It is to be understood that such a variation is always included in a given value provided herein, whether or not it is specifically referred to.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to space resources processing, and more particularly to systems and methods for in-situ regolith and metal fuel reactions for additive manufacturing.

To address the various limitations and challenges present in existing methods, embodiments disclosed herein describe in-situ regolith reactions for additive manufacturing and construction. Material may be provided in a vacuum chamber, where the material contains metal fuels (e.g., magnesium, aluminum) and an oxidizer (e.g., regolith). The material may then be ignited to combustion.

It was hypothesized that an aluminum fuel additive, while less reactive, may produce a product with improved physical properties. Techniques disclosed herein present self-sustaining thermite reactions of Mg/Al/JSC-1A pellets with the goal of using the post combustion products for construction and manufacturing. This is the first work analyzing a self-propagating, dual metal fuel thermite reaction with regolith simulant for AM space applications. A range of material compositions and processing parameters are addressed to evaluate their effects on the physical properties of the product. The effects of magnesium and aluminum loading demonstrate a wide range of tunable capabilities that can be optimized for manufacturing. These techniques may be used as a starting point for optimizing combustion based AM systems in space.

Advantageously, using in-situ materials will reduce the amount of material required to be brought from Earth to the Moon during missions, thereby reducing the cost of lunar missions and allowing cargo space for other resources during launch. Launch costs will therefore also be reduced.

Overall, processes disclosed herein will be fundamental building blocks for humans exploring and inhabiting the lunar and/or Martian surface and may provide the potential to greatly accelerate lunar infrastructure development.

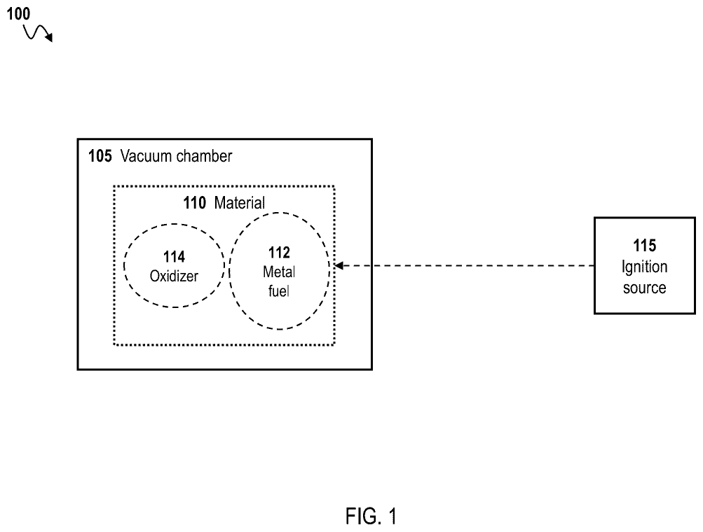

Referring now to FIG. 1, shown therein is a cross-section of a system 100 for additive manufacturing, according to an embodiment.

The system 100 includes a vacuum chamber 105 configured to contain a material 110.

The material 110 includes a metal fuel 112 and an oxidizer 114.

It will be understood that depictions of the metal fuel 112 and the oxidizer 114 are only examples and are not limiting. As such, there may be any number of different metal fuels and oxidizers present in the vacuum chamber 105.

The system 100 further includes an ignition source 115 configured to ignite the material 110 to combustion.

In an embodiment, the metal fuel 112 includes at least one of magnesium, and aluminum.

In an embodiment, the material 110 composition is at least one of 20% magnesium, 10% aluminum, 70% oxidizer; 15% magnesium, 15% aluminum, 70% oxidizer; and 10% magnesium, 20% aluminum, 70% oxidizer.

In an embodiment, the oxidizer 114 is at least one of lunar regolith, Martian regolith, and a regolith simulant.

In an embodiment, a pressure inside the vacuum chamber 105 is less than 200 Pa.

In an embodiment, the ignition source 115 is a laser.

In an embodiment, the ignition source 115 is an electromagnetic source including but not limited to the use of optical spark ignition (LEDs or fiber-optic systems), masers, inductive heating, radio frequency ignition such as spark plugs, plasma jets, arc discharge ignition, pulsed or continuous microwaves, electromagnetic ignition systems, infrared, electron beam, x-ray sources, terahertz radiation, optical ignition, hot wires or surface heaters, catalytic heaters, magnetron-driven ignition systems, electrostatic ignition, resistive heating elements, electric heating coils or the like.

In an embodiment, the ignition source 115 is derived from solar energy, it may include a solar concentrator composed on reflective collector, where solar energy is reflected to a receiver. Furthermore, the solar concentrator may use a plurality of Fresnel lens to concentrate the sunlight.

In an embodiment, the ignition source 115, is used for heat generation for sintering application.

In an embodiment, a series of thermite mixtures of magnesium, aluminum, and lunar regolith simulant (e.g., JSC-1A) are prepared.

In an embodiment, the composition and regolith simulant particle sizes are varied across the samples to determine their effect on the combustion and mechanical performances during, and after combustion.

In an embodiment, the particle size of the regolith simulant is dictated by ball milling for 1, 5, and 10 hours.

The metal fuel particles may or may not be ball milled as magnesium has the potential to combust during ball milling due to its reactivity and the aluminum particles were already significantly small with maximum diameters of 1 μm.

In an embodiment, the magnesium particles are a fine micro-sized powder and sieved through a 325 mesh (44 μm diameter).

In an embodiment, AlSi10Mg is used instead of aluminum to simulate potential recycled fuel material on the lunar surface as AlSi10Mg is used in aerospace structures.

In an embodiment, a maximum AlSi10Mg particle size may be 20 μm.

In an embodiment, recycled materials sourced from lunar infrastructure is used as the metal and/or metal oxide.

In an embodiment, recycled materials sourced from space debris is used as the metal and/or metal oxide.

In an embodiment, metals may include silicon, aluminum, iron, calcium, magnesium, sodium, potassium, manganese, chromium and titanium and other rare earth elements or the like. Furthermore, metal-oxides may include SO₂, Al₂SO₂, TiO₂, MgO, CaO, FeO, Na₂O, K₂O, P₂O₂, Cr₂O₃, MnO.

In an embodiment, metal oxides may include iron oxides, silicon dioxides, aluminum oxides, calcium oxides, magnesium oxides, titanium oxides, manganese oxides, sulfur oxides, chromium oxides, nickel oxides and cobalt oxides.

The three compositions by weight that were selected for testing were: A: 20% Mg, 10% Al, 70% simulant, B: 15% Mg, 15% Al, 70% simulant, and C: 10% Mg, 20% Al, 70% simulant. These compositions were selected based on previous work demonstrating successful sintered pellets using 20% Mg and 80% lunar regolith simulant.

Sample preparation began by weighing 25 g of JSC-1A lunar regolith simulant and ball milling for a prescribed length of time. The simulant was ball milled using a 6-inch diameter mill with four 1-inch diameter stainless steel balls at a rotation speed of 60 rpm. After ball milling the simulant powder was combined with magnesium and aluminum fuels and hand mixed until evenly dispersed. After mixing the powder was compressed into pellets measuring 30 mg in a custom cylindrical mold with a diameter of 3 mm at 250 psi for 1 minute. Four samples were created for each composition and particle size to gather adequate data, with the exception of DSC-TGA tests, where only one sample was used due to time constraints.

In an embodiment, particle size measurements are taken using Dynamic Light Scattering (DLS) to measure the diameter of the smallest particles of the regolith simulant.

In an embodiment, the microstructure of the thermite powders and sintered products were observed using a FEI Quanta FEG 250 ESEM for Scanning Electron Microscopy (SEM) and Energy Dispersive Spectroscopy (EDS).

In an embodiment, differentiative Scanning calorimetry and Thermogravimetric Analysis (DSC-TGA) of powdered samples were analyzed by a Netzsch STA 449 F1 from room temperature to 1200° C. at a heating rate of 20° C./min under the protection of an argon flow at 200 mL/min.

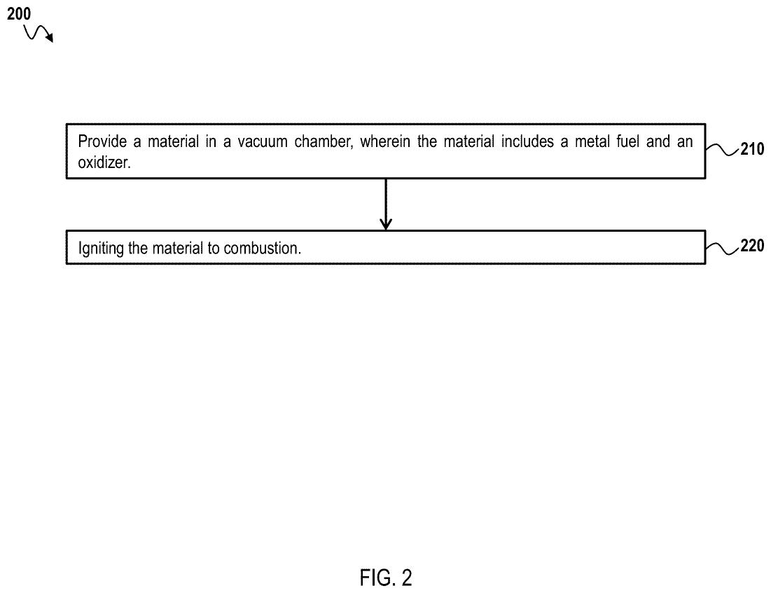

Referring now to FIG. 2, shown therein is a flowchart of a method 200 for additive manufacturing, according to an embodiment.

At 210, the method 200 includes providing a material in a vacuum chamber, wherein the material includes a metal fuel and an oxidizer.

At 220, the method further includes igniting the material to combustion.

In an embodiment, the metal fuel includes at least one of magnesium, and aluminum.

In an embodiment, the material composition is at least one of 20% magnesium, 10% aluminum, 70% oxidizer; 15% magnesium, 15% aluminum, 70% oxidizer; and 10% magnesium, 20% aluminum, 70% oxidizer.

In an embodiment, the oxidizer is at least one of lunar regolith, Martian regolith, regolith simulant, materials from Earth, and space debris.

In an embodiment, a pressure inside the vacuum chamber is less than 200 Pa.

In an embodiment, igniting includes using a laser.

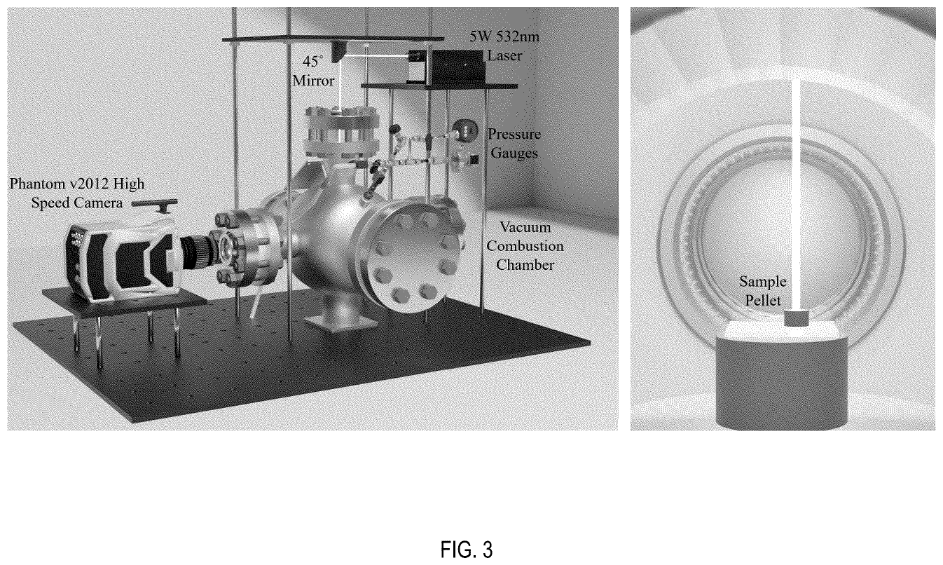

In an embodiment, compressed pellets may be weighed using a lab scale, and measured using a caliper prior to combustion to gather initial measurements. Vacuum combustion may be performed on each sample set to cause the samples to react and sinter together. The vacuum combustion tests may be carried out in a 0.5 cubic feet stainless steel chamber with a vacuum pump and observation windows for imaging and with a 5 W 532 nm laser for ignition, as seen in FIG. 3.

The vacuum chamber 105 may be pumped down to under 200 Pa prior to each ignition to simulate the lunar environment. High-speed combustion video was captured at a rate of 2000 frames per second using a Phantom v2012 monochrome fast camera with a 250 μs exposure time. The pellets were collected after combustion to be weighed and measured to calculate the change in mass and size due to combustion. At this time the samples were also analyzed for cracking during combustion. Lastly the samples underwent destructive mechanical testing to determine their compressive strength. Three pellets that did not display surface cracking were placed under a metal plate in a triangular formation for this test. Weight was added to the plate in 1.25 lbs increments each second until the samples fractured and collapsed up to a maximum of 120 lbs. While compressive tests of small samples are not an accurate representation of the true compressive material strength, the compressive strength are compared to that of pressed pellets that were not combusted of the same size as a reference baseline.

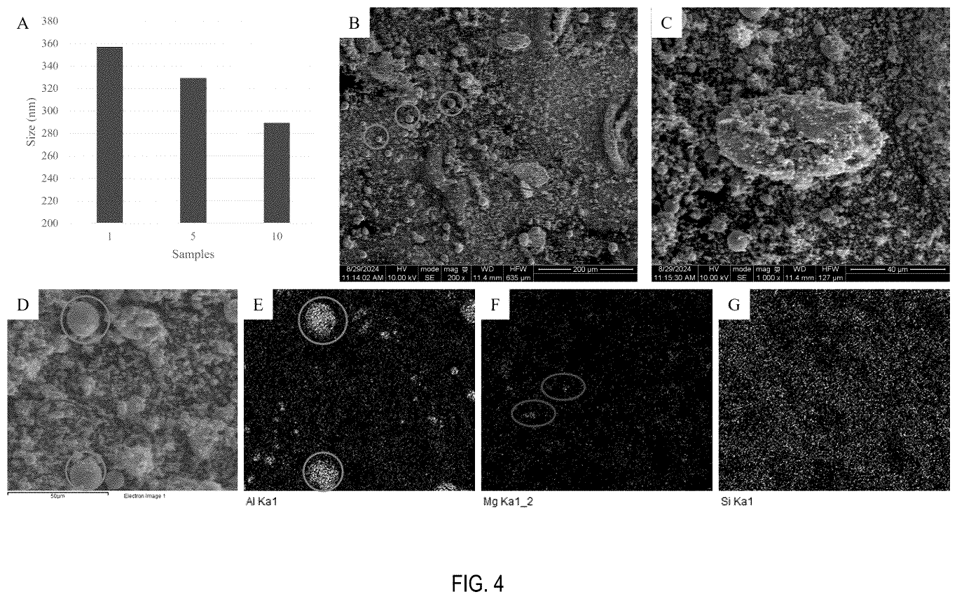

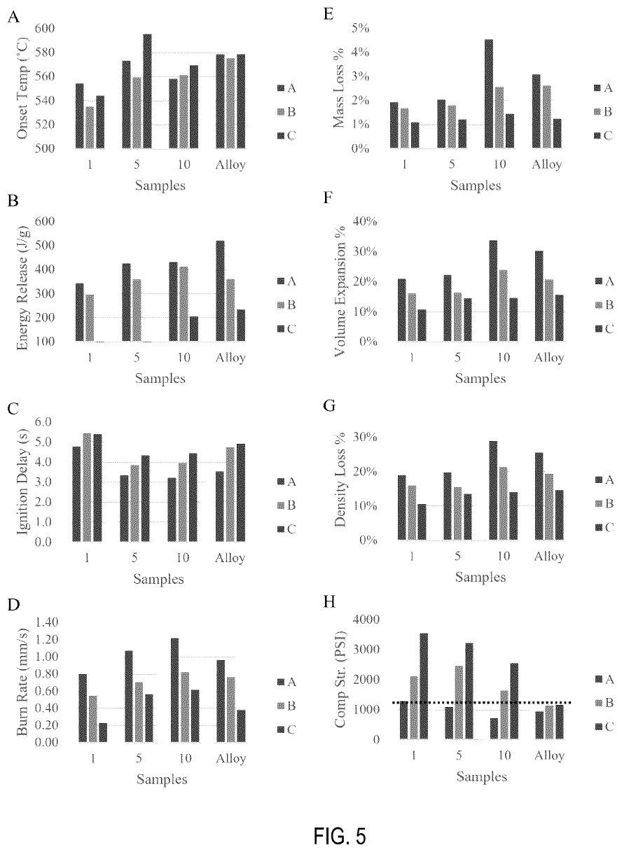

Referring now to FIG. 4, shown therein are images of material characterization before combustion including (A) simulant particle sizing based on ball milling duration (B-D) SEM images and (E-G) EDS images corresponding to image D for aluminum, magnesium, and silicon, respectively, according to an embodiment.

Particle size is known to have various effects on the mechanical and combustion properties of thermite materials. As mentioned previously, the particle sizes of magnesium, aluminum, and aluminum alloy used as fuels are 44, 1, and 20 μm, respectively. The particle sizes of the milled regolith particles were measured using DLS, and are demonstrated in FIG. 4, Image A, showing a decrease in particle size as the ball milling times increase. Note that DLS is not the optimal method for particle sizes measurement as it is limited to a size range of 200-600 nm due to particle agglomeration and sedimentation. This will be used as a representation of the distribution of the smallest particles after milling.

The microstructure of the mixed thermite powders prior to pressing and combustion were analyzed with SEM and EDS. FIG. 4, Images B-G depict the SEM (BD) and EDS (E-G) images of the mixture composed of 20% magnesium, 10% AlSi10Mg, and 70% simulant milled for 10 hours. FIG. 4, Image B demonstrates a low magnification view of the microstructure of the powder. Larger Mg (˜40 μm) and AlSi10Mg (˜10-20 μm) particles can be seen highlighted by red and blue ellipses, respectively. The aluminum particles are seen to be very spherical, whereas the Mg particles are jagged and not consistent in their shape. A magnified view of one of the large Mg particles is seen in FIG. 4, Image C. Surrounding the large Mg particle is a homogeneous mixture of Mg, AlSi10Mg, and simulant particles, smaller than 1 μm, which are measured via DLS. The very small simulant particles are seen as a result of the ball milling process which showed that longer ball milling times led to smaller particles. The small particle sizes and homogeneous distribution will aid in reaction propagation during combustion and sintering of the thermite material. FIG. 4, Image D shows the SEM image used for EDS measurements. FIG. 4, Images E-G show the EDS measurements for Al, Mg, and Si, respectively. High concentrations of Al and Mg are highlighted in the EDS images and overlayed on the SEM image. Al and Mg are also seen scattered throughout the material as they are found in less concentrated amounts throughout the minerals in the simulant. Silicon, which is the most abundant element in the simulant, is evenly distributed. The even distribution of simulant, and therefore oxygen, is important for reliable combustion during the thermite reaction.

Referring now to FIG. 5, shown therein are graphs of thermal, physical, and mechanical properties of materials during and after combustion including: (A) onset temperature, (B) energy release, (C), ignition delay, (D) burn rate (E) mass loss, (F) volume expansion, (G) density loss, and (H) compressive strength, according to an embodiment.

The samples may be first combusted using DSC-TGA to determine the thermal properties under a controlled, slow heating environment. Note that each sample was tested once in DSC-TGA for this set of experiments due to time constraints. Ideally several trials would be completed for each composition and particle size to obtain accurate measurements. During the heating process from room temperature to 1500° C., each sample demonstrated one major exothermic peak after the initiation of the thermite reaction caused by magnesium and the oxidizing simulant, which also caused the aluminum to react with the simulant oxidizer. The onset temperature of the reactions ranged from 535-595° C. and is demonstrated in FIG. 5, Graph A. The variance in the values and trends of the onset temperature measurements are typical of these single trial DSC-TGA measurements. Also using the DSC results, the energy density of the material was calculated and is shown in FIG. 5, Graph B. It can be seen that smaller particle sizes led to a higher energy density due to the increased reaction caused by increased surface contact between particles. It can also be seen that samples with higher magnesium content released more energy due to its higher reaction enthalpy with the simulant oxidizers than aluminum. When the samples were aluminum rich and used simulant that had been ball milled for 1 and 5 hours, there was not a significant reaction peak during heating. The decrease in reactivity is a common phenomenon that has been reported in DSC-TGA due to its slow heating in a controlled environment.

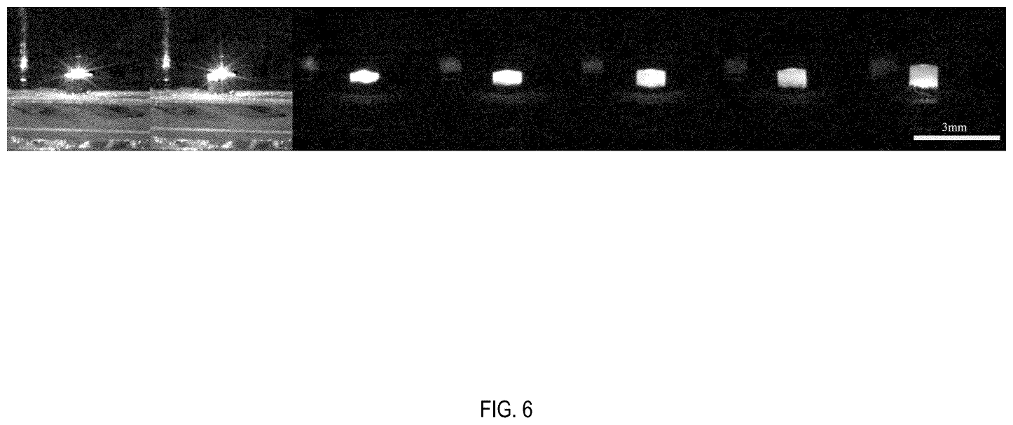

Ignition tests in a vacuum were then completed for each sample to demonstrate their combustion properties under rapid heating. FIG. 6 demonstrates the high-speed image frames during the combustion test of a 20% Mg/10% Al-alloy/70% simulant. The ignition delay and burn rates of the samples can be seen in FIG. 5, Graphs C and D, respectively. The ignition delay decreased with both a decrease in simulant particle size, and an increase in magnesium content. The increased reactivity of these conditions meant that less power was required to achieve sufficient energy for a runaway reaction. It is shown that there is an increase in ignition delay when the aluminum alloy is used instead of aluminum, also due to the decreased reactivity when compared to pure aluminum metal. Overall, using a 5W laser it can be calculated that 15-27 J of energy was required for the ignition of the samples. The burn rates are seen to range from 0.2-1.2 mm/s, increasing with magnesium content and with decreasing particle size. Additionally when AlSi10Mg was used instead of aluminum, the burn rate decreased slightly as the AlSi10Mg would need to decompose before reacting. Both the ignition delay and burn rate will be important pieces of information if this material were to be used at a larger scale in practice.

The post-combustion material properties will be critical to determining its viability as an AM material. The changes in material properties before and after combustion will also provide insight into how the material is changing during combustion and its use as an AM material. Once the combustion experiments were completed, the mass and volume of the thermite pellets were measured. FIG. 5, Graphs E-G demonstrates change in mass, volume, and density of the samples after combustion has occurred. Across all samples it can be seen that combustion causes a mass decrease and a volume increase, leading to a decrease in density of the product.

The samples consistently demonstrated that higher magnesium concentration led to greater mass loss and volume expansion. These effects are caused by the vaporization of magnesium during the high temperature combustion. As the magnesium vaporizes it has several effects on the combusting pellet that may all occur simultaneously. The magnesium can react with the surrounding simulant oxidizer to react and release heat, it can increase the pellet volume due to the buildup of pressure within the pores of the pellet causing expansion, and the magnesium vapor can escape into the vacuum. Across the samples there was an approximately linear correlation between the mass loss/volume expansion and the amount of magnesium in the samples. Additionally, the reactions with increased magnesium are more rapid and more energetic which is hypothesized to cause the material to break apart more easily, furthering the volume expansion and mass loss. Contrarily, aluminum will only melt during the combustion as the temperature of the reaction will not reach its boiling point. Therefore, it will not cause mass loss to the system, however it may still cause volume expansion due to increased pressure and the liquid flow of aluminum fuel throughout the sample. Aluminum also reacts in a less energetic manner, decreasing the presence of porosity and fractures in the material. It was also demonstrated that smaller oxidizing particle sizes led to greater mass loss and volume expansion. The smaller oxidizing particles increase the completeness and rate of the reaction, leaving fewer unreacted particles as product. Therefore any particles that would vaporize, in this case magnesium, do so to a greater degree, as shown in the results of FIG. 5. The aluminum alloy particles can be seen to limit this reaction completeness and rate as the mass loss and volume expansion are not as large compared to the reactions with aluminum microparticles due to the additional silicon.

FIG. 5, Graph H demonstrates the measured compressive strength of the pellets. Also included in the figure is the average baseline strength of the pressed pellets before combustion at 1,370 psi. It can be seen that the composition and particle size have large effects on the physical strength of the material after combustion, as some samples increase in strength and others decrease in strength. Notably, the samples containing higher concentrations of magnesium did not increase in strength, regardless of the simulant particle size. The vaporization of magnesium caused a large increase in porosity within the samples due to the more complete and energetic reaction causing a greater mass loss and volume increase. This will lead to a weaker sample that is also more susceptible to defects. The samples that contained even amounts of magnesium and aluminum, or those that contained more aluminum, increased in strength when the aluminum alloy was not used as fuel. In these samples the reaction caused the metallic particles to sinter together without the large increase in porosity caused by the evaporation of magnesium during. The magnesium was able to aid in causing a complete reaction between the metal fuels and the simulant oxidizer, and aluminum was able to react while remaining in a solid or liquid state, sintering nearby particles together. As the melting point of aluminum is about 660° C. it is able to melt and disperse within the sample to react and bind nearby particles together.

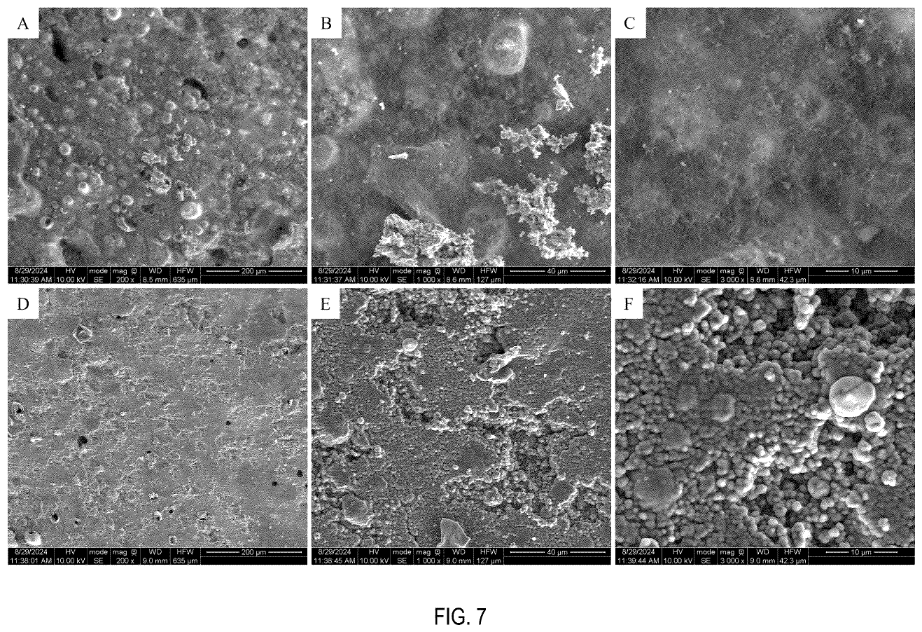

Referring now to FIG. 7, shown therein are microscopic imaging of post-combustion a 20% Mg/10% Al/70% simulant pellet (A-C) and a 15% Mg/15% AlSi10Mg/70% simulant pellet (D-F), according to an embodiment.

SEM images shown in FIG. 7 demonstrate the post combustion material of the Mg/Al/simulant pellets. FIG. 7, Images A-C show the top face of a pellet composed of 20% Mg/10% Al/70% simulant ball milled for 10 hours. The images depict some individual particles (A), sintered structures (A-B), and a hair like nest of material on the top surface of the pellet (C). FIG. 7, Image A shows that the sintering of these particles is not creating a uniform structure as it has several individual particles and small sintered agglomerations. The lack of larger sintered particles is expected as compressive strength of the sample was shown to have decreased after combustion. The high magnesium content is expected to cause less sintering and leave a more porous product. Small sintered particles on the order of tens of microns can be seen in FIG. 7, Image B. The hairlike structures in FIG. 7, Images A-C are strongly believed to be MgO that solidifies and crystallizes after vaporization. Past research has demonstrated the formation of MgO nanofibers after high temperature combustion processes. This type of formation is highly expected on the top surface of the pellet where heat, and therefore vaporous magnesium, will concentrate, forming the nanofiber structures. While not a focus of this study, the formation of MgO may have many applications in space due to its great thermal conductivity.

FIG. 7, Images D-F show the bottom face of a pellet composed of 15% Mg/15% AlSi10Mg/70% simulant ball milled for 10 hours. It can be seen that there are both similarities and differences between the microstructures of the top and bottom surfaces of the pellets. Most notably, there is a lack of nanofibers on the bottom surface. This is most likely due to the fact that the vaporous magnesium will escape out the sides and top surfaces of the pellet, rather than settle on the substrate. Additionally, any fibrous wires that would settle on the substrate, in this case tape, would likely be left on the substrate post-combustion. Lastly, the amount of magnesium in this sample is less, leading to less MgO formation. The degree of sintering between the particles appears to be fairly similar to the sample in Images A-C. This is expected as the physical and chemical properties across these two samples were all nearly identical. It can be seen in FIG. 7, Image F that some of the particles sinter together and create larger solid particles, however there are still many cracks and defects, as seen in FIG. 7, Images D-F.

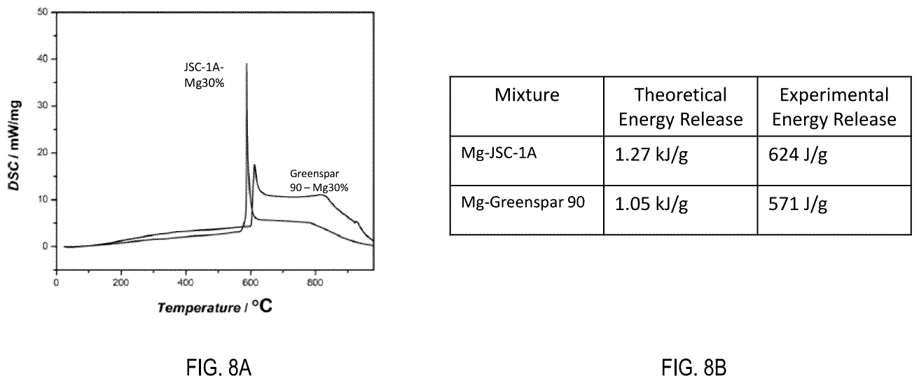

FIGS. 8A-15 are directed to a different embodiment with different methodologies than FIGS. 4-7. The systems and methods of FIGS. 8A-15 include the use of two lunar simulants, JSC-1A simulant, as already discussed herein, as well as a second simulant, Greenspar 90. JSC-1A is a mare simulant and Greenspar 90 is a highland simulant. The chemical compositions of the simulants is shown below in Table 1.

TABLE 1

| | | |
|---|---|---|
| Oxide | JSC-1A | Greenspar 90 |

| D₅₀ | ~100 | μm | ~20 | μm |
|---|---|---|---|---|
| SiO₂ | 47.71 | μm | 50.18 | μm |
| Al₂O₃ | 15.02 | μm | 30.88 | μm |
| CaO | 10.42 | μm | 14.58 | μm |
| MgO | 9.01 | μm | 0.19 | μm |
| FeO | 7.35 | μm | N/A | |
| Fe₂O₃ | 3.44 | μm | 0.49 | μm |
| Na₂O | 2.7 | μm | 2.63 | μm |
| TiO₂ | 1.59 | μm | 0.05 | μm |
| K₂O | 0.82 | μm | 0.23 | μm |
| P₂O₅ | 0.66 | μm | 0.01 | μm |

As can be seen in Table 1, JSC-1A is richer than Greenspar 90 in MgO TiO₂, and FeO, while Greenspar 90 is richer than JSC-1A in Al₂O₃ and CaO. The theoretical release energies for JSC-1A are: for Mg, 1.27 KJ/g, and for Al, 0.97 KJ/g. The theoretical release energies for Greenspar 90 are: for Mg, 1.05 KJ/g, and for Al, 0.72 KJ/g.

The system and methods describe above for FIGS. 1-7 may be used for the compositions described within the embodiments and methods described in FIGS. 8A-15.

The compositions and methodologies discussed and shown for FIGS. 8A-15 are as follows. The lunar regolith simulant (JSC-1A or Greenspar 90) was mixed at different ratios with Mg using ball milling. The reaction of the lunar regolith simulant and Mg was investigated by Thermogravimetric analysis-Differential Scanning calorimetry (TGA-DSC). Scanning Electron Microscope (SEM) and X-ray diffraction (XRD) studies were used to characterize morphologies and chemical compositions of the lunar regolith and reaction products. Kinetic parameters were calculated and combustion tests were performed to determine reaction characteristics. Three different Mg weight percentages were used: 20% (ER=0.8, “fuel lean”), 30% (ER=1.4, “fuel rich”), and 40% (ER=2.2, “fuel rich”).

FIG. 8A shows a graph for an activity test performed with TGA-DSC for both JSC-1A and Greenspar 90.

The graph includes the temperature output on the x-axis and the differential scanning calorimetry (in mW/mg) on the y-axis. The graph is for an experiment including the 30% fuel rich Mg.

FIG. 8B is a table showing the theoretical energy release for the experiment of FIG. 8A and the realized experiment energy release.

Both JSC-1A and Greenspar 90 react exothermically with Mg, however, the reaction occurs at a lower temperature for JSC-1A due to the higher iron percentage of JSC-1A.

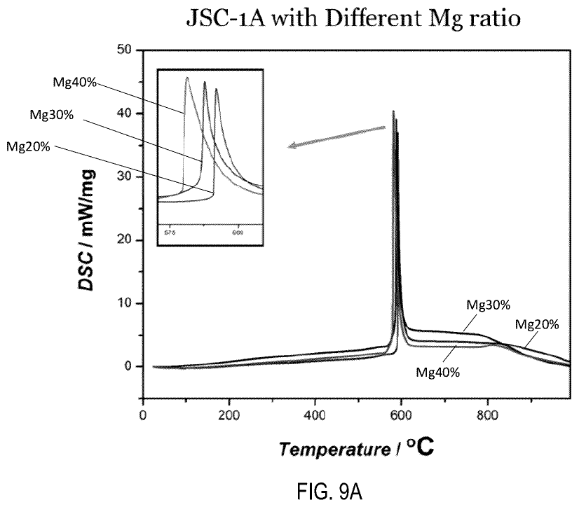

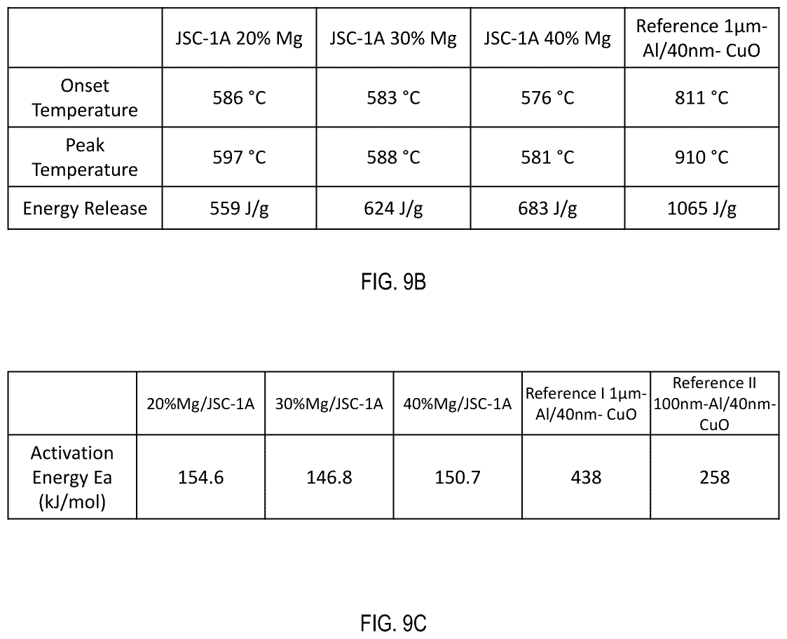

FIG. 9A shows a further TGA-DSC experiment for different percentages of Mg reacting with JSC-1A. As expected, there is a reduced onset temperature and peak temperature as the percentage of Mg increases.

FIG. 9B is a table showing the precise values for onset temperature, peak temperature, and energy release when Mg reacts with JSC-1A at various percentages. A reference reaction of a typical thermite 1 μm Al with 40 nm CuO is also shown. As above, the onset and peak temperatures decrease with a higher amount of Mg, possibly due to reduced diffusion length. Energy release increased with additional Mg, but was not significant.

FIG. 9C is a table showing activation energy as calculated based on the peak temperature from the different heating rate of the DSC experiments. The activation energies of the various percentages of Mg reacting with JSC-1A were similar (20% Mg-154.6 KJ/mol, 30% Mg-146.8 KJ/mol, and 40% Mg-150.7 KJ/mol,) due to the reaction mechanism being the same. The activation energy of the reference thermite, 1 μm Al with 40 nm CuO, and reference nanothermite, 100 nm-Al with 40 nm CuO, are much higher, which indicates that Mg is much more reactive than Al.

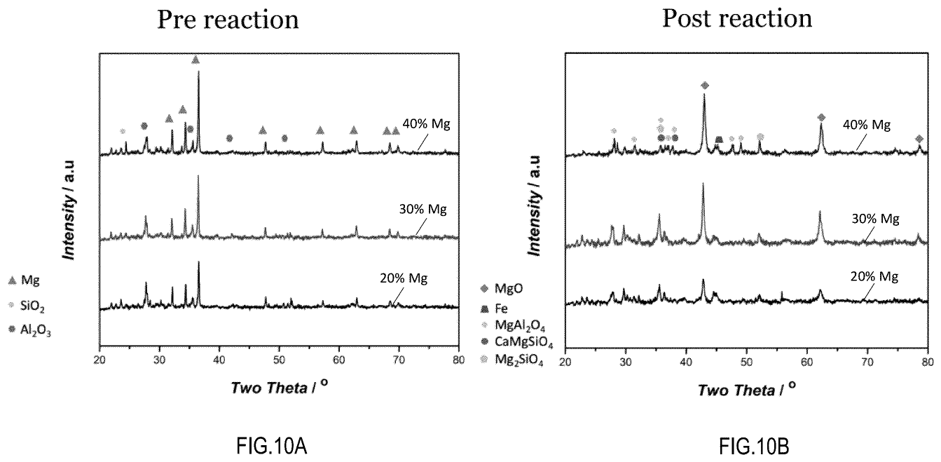

FIGS. 10A and B are graphs representing an x-ray diffraction showing the products of the reaction. The compounds/elements found before a reaction are shown in FIG. 10A and the compounds/elements found after the reaction are shown in FIG. 10B.

FIG. 10A shows that Mg, SiO₂, and Al₂O₃ are found pre-reaction. FIG. 10B shows that MgO, Fe, MgAl₂O₄, CaMgSiO₄, and Mg₂SiO₄ are present post-reaction. This suggests that a reaction with active metal oxide(s) and SiO₂ cannot easily generate a pure metal or Si, but does generate co-oxidizers (MgAl₂O₄, CaMgSiO₄, and Mg₂SiO₄).

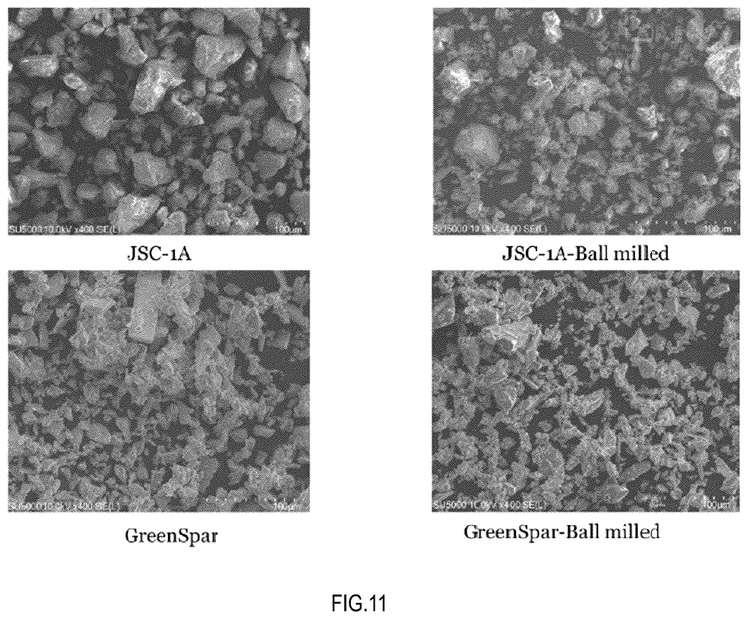

FIGS. 11-17A shows various scanning electron microscope (SEM) images of various compounds discussed herein.

FIG. 11 shows SEM images of JSC-1A before and after ball milling, and Greenspar 90 before and after ball milling.

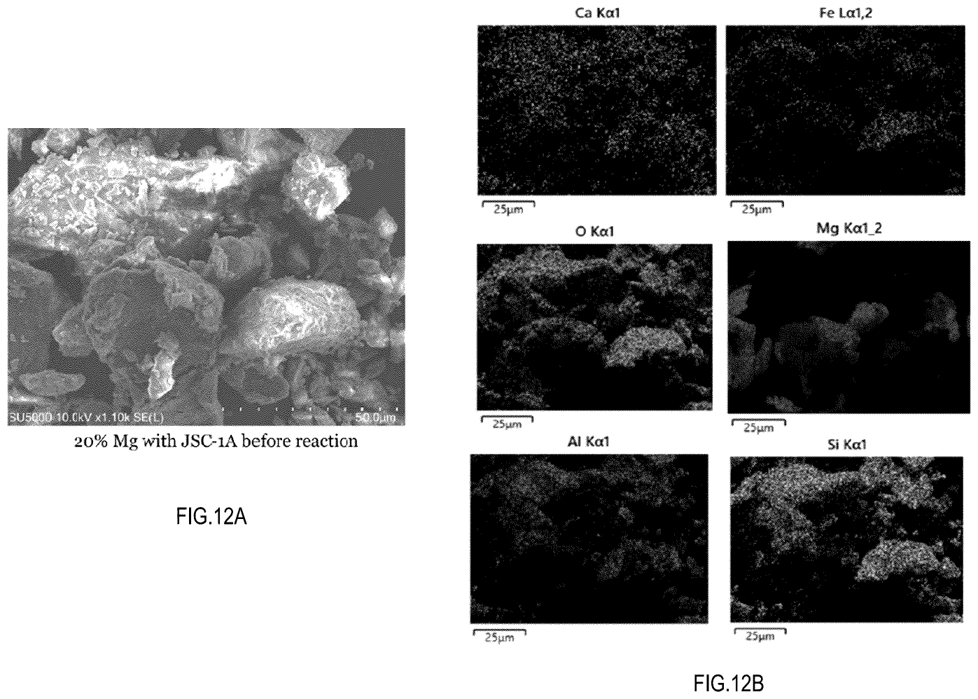

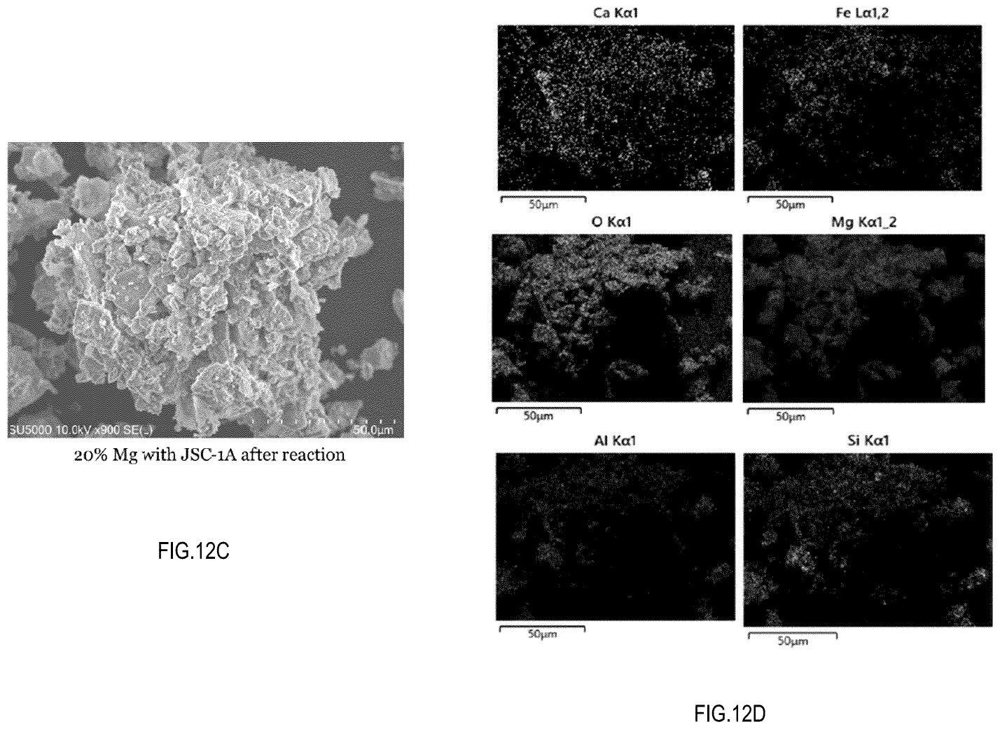

FIG. 12A shows a mixture of 20% Mg with JSC-1A before a reaction has occurred. The brighter spots shown in FIG. 12A indicate non-conductive lunar regolith.

FIG. 12B shows the location of elements calcium, iron, oxygen, magnesium, aluminum, and silicon within the same SEM image of FIG. 12A.

FIG. 12C shows an SEM image of 20% Mg with JSC-1A after a reaction.

FIG. 12D shows the location of the elements, Ca, FE, O, Mg, Al, and Si, within the same SEM image of FIG. 12C. The elements have the same distribution indicating that a reaction has occurred.

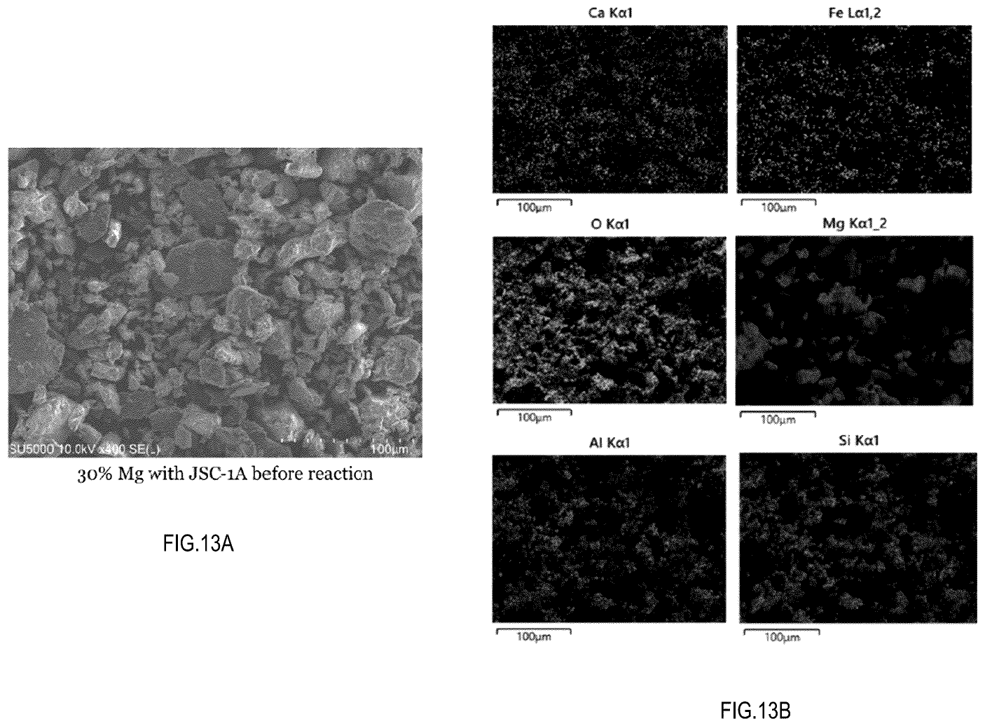

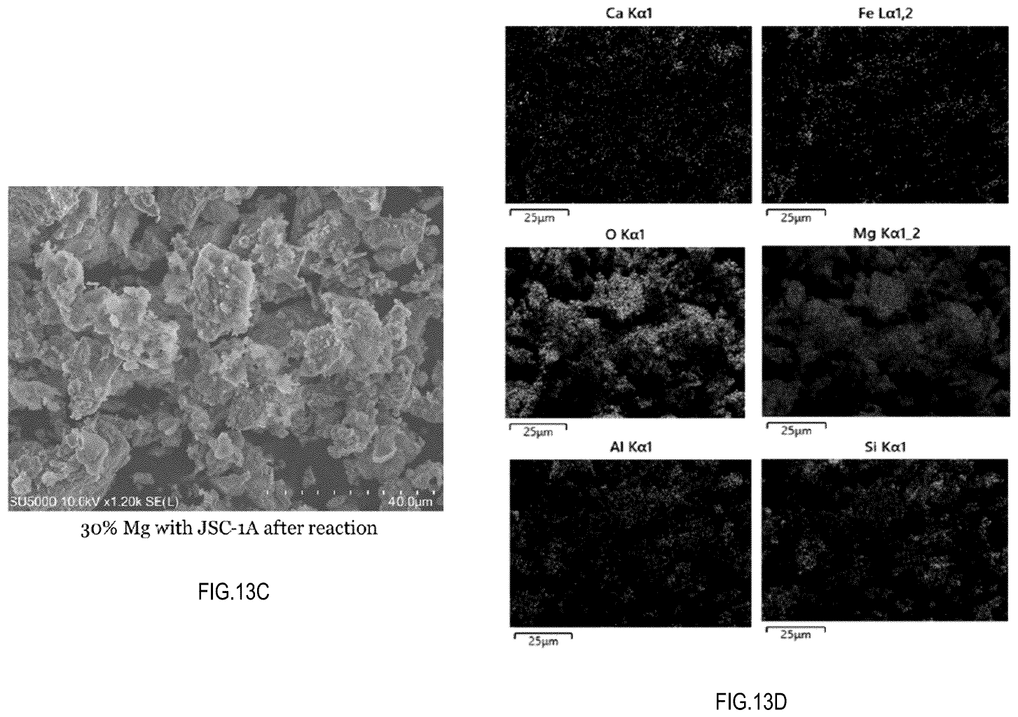

FIG. 13A shows a mixture of 30% Mg with JSC-1A before a reaction has occurred. The brighter spots shown in FIG. 13A indicate non-conductive lunar regolith.

FIG. 13B shows the location of elements Ca, FE, O, Mg, Al, and Si within the same SEM image of FIG. 13A.

FIG. 13C shows an SEM image of 30% Mg with JSC-1A after a reaction.

FIG. 13D shows the location of the elements, Ca, FE, O, Mg, Al, and Si, within the same SEM image of FIG. 13C. The elements have the same distribution indicating that a reaction has occurred.

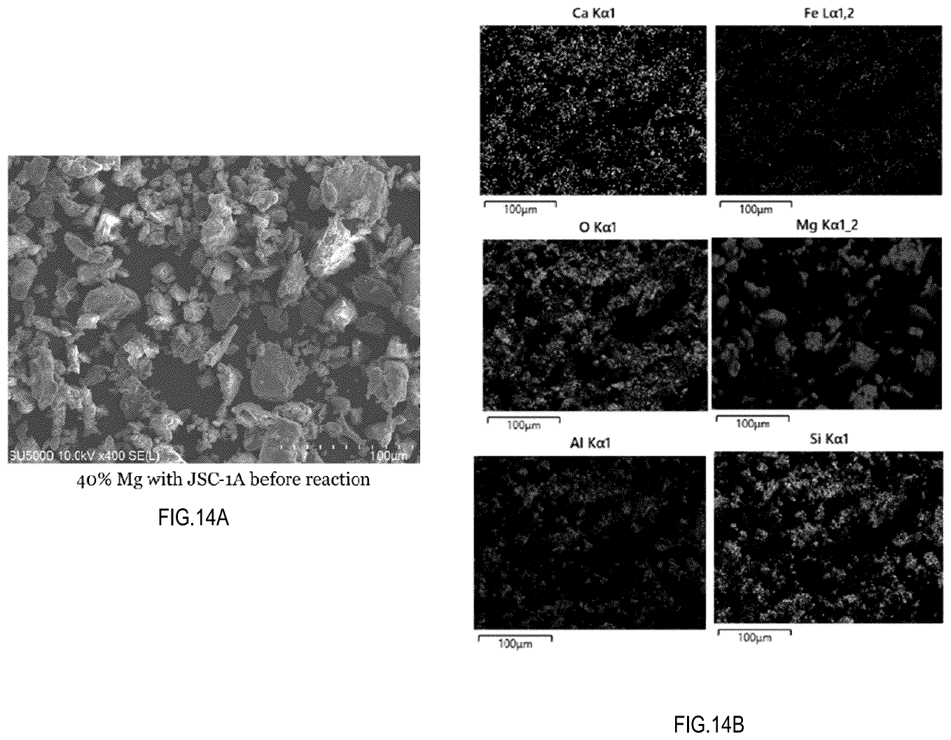

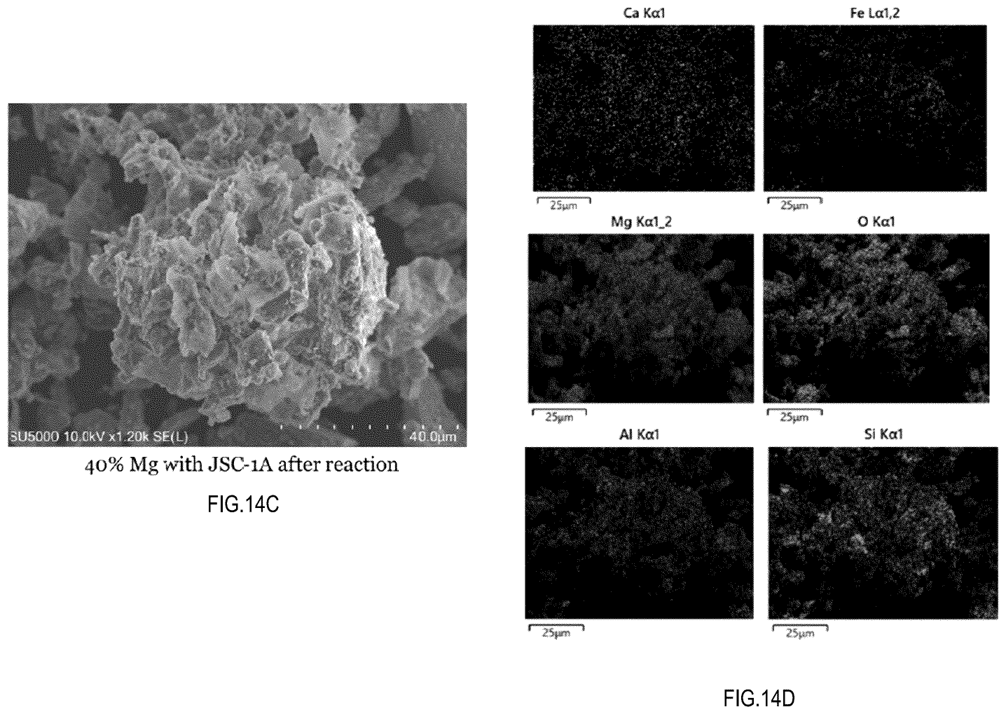

FIG. 14A shows a mixture of 40% Mg with JSC-1A before a reaction has occurred. The brighter spots shown in FIG. 14A indicate non-conductive lunar regolith.

FIG. 14B shows the location of elements Ca, FE, O, Mg, Al, and Si within the same SEM image of FIG. 14A.

FIG. 14C shows an SEM image of 40% Mg with JSC-1A after a reaction.

FIG. 14D shows the location of the elements, Ca, FE, O, Mg, Al, and Si, within the same SEM image of FIG. 14C. The elements have the same distribution indicating that a reaction has occurred.

The SEM results for each percentage of Mg showed almost identical morphology indicating similar reaction pathways and products.

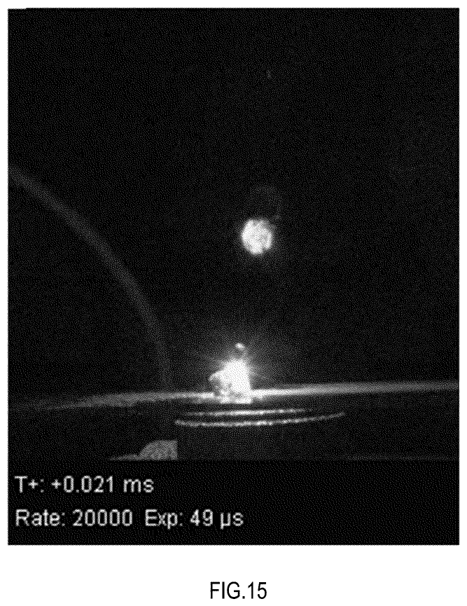

In a combustion test, as shown in FIG. 15, it was found that the rate of combustion was very slow for Mg and JSC-1A, with no explosion observed. This may be due to low reactivity and large particle size of Mg and lunar regolith. A compressed 4 mm diameter, 3 mm height, and 2 g/cc density pellet of Mg/JSC-1A was used for the test shown in FIG. 15 and a 3.5 W laser was used to ignite the sample. The reaction was self-sustained across the entire pellet.

The methodologies of the embodiment shown in FIGS. 8A-15 show that Mg reacts with lunar regolith, and that a mare regolith provides a higher reactivity than a highland regolith due to the higher iron oxide and titanium oxide amounts.

Overall, there are many critical features that dictate the final properties of the reactive regolith-based thermite material. It will be important to identify and control these features if these materials are to be used in a sustainable additive manufacturing or construction process. The amount of magnesium and aluminum strongly dictate the thermal and physical properties of the product, and the oxidizing particle sizes have a supporting role in adjusting these properties further. It was shown that excess magnesium will cause high reactivity and low physical strength due to the high reactivity and low boiling point of magnesium. It was also shown that excess aluminum will cause limited reactivity, but when reaction is achieved a higher physical strength is demonstrated due to the melting of aluminum rather than vaporization. The optimization of the material properties can be achieved by fine tuning the compositions and particle sizes of the thermite.

It is also important to note that these techniques may also be translated to Mars applications due to the similarities in lunar and Martian regolith. As Martian regolith is also composed of oxygen rich minerals it is possible to create thermite-based fuel for additive manufacturing and construction out of it. Martian regolith contains more iron than lunar regolith, and less aluminum and magnesium. Therefore, the reactivity of the thermite produced will be increased and will affect the thermal and physical properties analyzed in this report. With increased reactivity it is predicted that less magnesium would be required to achieve self sustained propagation and a greater amount of aluminum could be used, increasing the final strength of the product. In an ideal case this material and required technology could be tested on the lunar surface prior to being used on Mars with limited changes being required for the new environment.

It is also notable that the materials used in this process could all be found in-situ on the moon and mars. If in-situ processing methods were able to separate the magnesium and aluminum from lunar and Martian regolith, a fully in-situ fuel could be developed increasing the sustainability of the thermite material. This will be critical for Mars missions where resupply will not be an option for metal fuel acquisition.

Advantageously, the material described herein could be applied to other techniques and technologies. The material could also be used in welding or joining processes, especially if the joining of regolith made parts is required. If the combustion method is combined with a heat capture process, the thermite reaction could be used both for construction and for heat/energy generation simultaneously. This dual use system could be used to benefit two areas of lunar and Martian infrastructure development that are currently being researched.

In an embodiment, the materials undergo combustion to generate heat, the heat is then converted to electrical energy using the thermionic emission of electrons. For example, a hot electrode such as tungsten emitter is heated using a solar collector which heats thermites and generates heat leading to thermionic emission. The electrons flow to the cold electrode (made of molybdenum, platinum or other metals with good thermal conductivity) generating a current, this current is then directed toward an external load. Furthermore, the external load can be a plurality of batteries, capacitors, thermal batteries, electric propulsion systems (such as ion or Hall-effect thrusters), and/or connected to other subsystems.

In some embodiments, metals and metallic alloys may be sourced from Earth. In other embodiments, sources may include recycling space debris, retired satellites in orbit, second stages, empty fuel tanks, or other materials transported from Earth to space. In other examples, metal and metal alloys may be sourced from space. Sources may also include materials from the Mars (Martian regolith), asteroid sources, planetoids, other celestial bodies or a combination thereof.

In some embodiments, regolith undergo transformations using in-situ resources processing methodologies such as: carbo-thermal methods, molten-regolith electrolysis, FFC Cambridge Method, Vapor Phase Pyrolysis, Solar Smelting, Water Electrolysis to create high-purity metals, ceramics, oxygen, ceramic, glass, semiconductors, polymers, alloys that are used to construct structures on the Moon or Mars.

In some embodiments, these methods are used for industrial heating applications, where metals and metal alloys are manufactured to produce a self-replicated factory. Where materials are sourced from the Moon or Mars to produce bricks or concrete for tools, machinery, structural components, habitats, roads, landing pads, and other infrastructure.

In some embodiments, the heat and/or electricity generated from the reactions may support the production of hydrogen and oxygen through splitting of water via electrolysis or the like.

In some embodiments, a first metal and a first metal oxides sourced from regolith are reacted in a reaction chamber to generate useful byproducts such as a second metal oxide and a second metal and a heat energy. The second metal oxide and second metal can be utilized to support power, propulsion and construction application, and the heat energy is harvested to drive other exothermic reactions. In other implementations, the second metal oxides is used a reducing agent. Furthermore the heat energy can be stored in a thermal battery and/or phase change materials or used to head a thermal conductive materials (tungsten) or the like to volumetrically maintain a desired temperature. In other implementations, the waste heat is used for extraction, refining, alloying, and shaping of metals.

In some embodiments, the heat generation is coupled with other energy sources to augment smelting, refining, and manufacturing operations, such as solar concentrators that provide high-temperature heat, molten salt electrolysis to extract metals directly from lunar regolith, microwave heating of regolith to produce building materials or processed to extract metals without needing combustion, and/or induction heating powered by solar or nuclear energy adapted to process metals for recycling, construction and manufacturing.

In some embodiments, lunar regolith-based dual fuel thermite materials may serve as a catalyst to drive other exothermic reactions.

In some embodiments, lunar regolith-based dual fuel thermite materials may be used a heat source to create alloys, steel, solar cells, photovoltaics, support regolith sintering applications where the regolith is heated to high temperatures to fuse particles together without melting completely.

In some embodiments, lunar regolith-based dual fuel thermite materials may be used to power satellites to transport materials from the lunar surface to orbit.

In some embodiments, lunar regolith-based dual fuel thermite materials may be used for heating applications to support of satellites, rovers, and other lunar or Martian infrastructure to survive cold temperatures.

In some embodiments, use of solar emissions and ions such as hydrogen can be used as an input for lunar regolith-based dual fuel thermite reactions to create a plurality of byproducts such as organic products and/or water.

Techniques disclosed herein present a combustion and physical analysis of novel in-situ lunar regolith-based dual fuel thermite materials. The use of magnesium and aluminum in thermite demonstrated a fine-tuning capability and enhanced characteristics that will enable its used as a manufacturing and construction material. The reactivity of magnesium paired with the strength of aluminum after combustion presented a mixture that may be ideal for self sustained manufacturing of energetic thermite products. The ability to create self sustaining reactions is demonstrated that left products that were mechanically stronger than the raw material. The show that the combustion and initial material properties may be used to hypothesize the physical characteristics of the final product. Several combustion, material, and mechanical properties are reported on to demonstrate the feasibility of this material as a construction material. Overall, the regolith-based thermite can be used as an AM feedstock or as construction material with the potential to develop key sustainable technology for lunar and Martian infrastructure and be a dual use technology that can generate energy from the thermite reaction.

While the above description provides examples of one or more apparatus, methods, or systems, it will be appreciated that other apparatus, methods, or systems may be within the scope of the claims as interpreted by one of skill in the art.

Elements of each embodiment may be incorporated into other embodiments, for example, configurations discussed in relation to one embodiment, may be applied to other embodiments disclosed herein.

Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present disclosure.

1. A system for additive manufacturing, the system comprising:
a vacuum chamber configured to contain a material, wherein the material includes a metal fuel and an oxidizer;
an ignition source configured to ignite the material to combustion.

2. The system of claim 1, wherein the metal fuel includes at least one of: magnesium, aluminum, iron, and titanium.

3. The system of claim 2, wherein the material composition is at least one of: 20% magnesium, 10% aluminum, 70% oxidizer; 15% magnesium, 15% aluminum, 70% oxidizer; 10% magnesium, 20% aluminum, 70% oxidizer; 20% magnesium, 80% oxidizer; 30% magnesium, 70% oxidizer; and 40% magnesium, 60% oxidizer.

4. The system of claim 1, wherein the oxidizer is at least one of: lunar regolith; Martian regolith; asteroidal materials; regolith simulant; recycled materials; materials from Earth; and space debris.

5. The system of claim 4 wherein the regolith simulant is one of: JSC-1A and Greenspar 90.

6. The system of claim 4 wherein the lunar regolith is a mare regolith.

7. The system of claim 4 wherein the lunar regolith is a highland regolith.

8. The system of claim 1, wherein a pressure inside the vacuum chamber is less than 200 Pa.

9. The system of claim 1, wherein the ignition source is a laser.

10. The system of claim 1, wherein the materials are sintered.

11. A method of additive manufacturing, the method comprising:
providing a material in a vacuum chamber, wherein the material includes a metal fuel and an oxidizer;
igniting the material to combustion.

12. The method of claim 11, wherein the metal fuel includes at least one of: magnesium; aluminum; iron; and titanium.

13. The method of claim 12, wherein the material composition is at least one of: 20% magnesium, 10% aluminum, 70% oxidizer; 15% magnesium, 15% aluminum, 70% oxidizer; 10% magnesium, 20% aluminum, 70% oxidizer; 20% magnesium, 80% oxidizer; 30% magnesium, 70% oxidizer; and 40% magnesium, 60% oxidizer.

14. The method of claim 11, wherein the oxidizer is at least one of: lunar regolith; Martian regolith; asteroidal materials; regolith simulant; recycled materials; materials from Earth; and space debris.

15. The method of claim 14 wherein the regolith simulant is one of: JSC-1A and Greenspar 90.

16. The method of claim 14 wherein the lunar regolith is a mare regolith.

17. The method of claim 14 wherein the lunar regolith is a highland regolith.

18. The method of claim 11, wherein a pressure inside the vacuum chamber is less than 200 Pa.

19. The method of claim 11, wherein igniting includes using a laser.

20. The method of claim 11, where the materials are sintered.
